(19) United States
(12) Patent Application Publication
(10) Pub. No.: US 2015/0139580 A1
(43) Pub. Date: May 21, 2015

(54) BOTTOM BRACKET ASSEMBLY FOR LOW-SPEED ROTATION

(71) Applicant: Shih-Tsao LIN, Taichung City (TW)

(72) Inventor: Shih-Tsao LIN, Taichung City (TW)

(21) Appl. No.: 14/086,300

(22) Filed: Nov. 21, 2013

(51) Int. Cl. B62M 3/00; F16C 33/20

(52) U.S. Cl. CPC B62M 3/003; F16C 33/20; F16C 33/201
USPC 384/462

(57) ABSTRACT

A bottom bracket assembly for low-speed rotation is formed of a main body having an axial hole running therethrough, a spindle inserted into the axial hole, and a pivotal assembly having a self-lubricating bearing, a bushing, and a ball valve, each of which is made of a self-lubricating material. The self-lubricating bearing is sleeved onto the spindle and located at one end of the axial hole. The ball valve includes a through hole running through an axis thereof and sleeved onto one end of the spindle relative to the self-lubricating bearing. The external diameter of the bushing is smaller than the internal diameter of the axial hole. The bushing includes a spherical bushing aperture for engagement with the ball valve to make the bushing deflected on the center of the ball valve and thus the rotation of the spindle remains stable and smooth.

### BACKGROUND OF THE INVENTION

1. Field of the Invention

The present invention relates generally to a rotating structure of a spindle and more particularly, to a bottom bracket assembly for low-speed rotation.

2. Description of the Related Art

A conventional spindle is rotatably mounted into a bushing aperture of a main body and is rotated coaxially relative to the bushing aperture to make the main body rotate. Such structure is commonly applied to bicycle pedals, bottom brackets, or rollers. To prevent the spindle and the bushing aperture from excessive frictional resistance therebetween leading to unsmooth rotation and tear, such conventional structure includes two ball bearings or self-lubricating bearings sleeved onto two ends of the spindle and serving as the rotary interface between the main body and the spindle to make the main body rotate smoothly. Since the spindle fully contacts the internal periphery of the bushing aperture of the main body, when the ball bearings or the self-lubricating bearings are sleeved onto the spindle, the bushing aperture of the main body needs to keep very precise to prevent the main body and the bushing aperture from overgreat frictional resistance therebetween and to prevent the main body and the bushing aperture from flicker or unsmooth rotation resulting from inconsistent axes thereof. In other words, when the conventional spindle is combined with the main body, mechanical processing must be applied to the spindle and the bushing aperture, so the processing cost and the assembly cost are too high. Besides, multiple metallic ball bearings are needed for the purpose of smooth rotation, so the conventional structure costs higher for the components to need further improvement.

### SUMMARY OF THE INVENTION

The primary objective of the present invention is to provide a bottom bracket assembly for low-speed rotation, which is structurally simple, easy in assembly, and structurally low-cost.

The foregoing objective of the present invention is attained by the bottom bracket assembly formed of a main body having an axial hole running therethrough, a spindle inserted into the main body, and a pivotal assembly having a self-lubricating bearing, a bushing, and a ball valve. Each of the self-lubricating bearing, the bushing, and the ball valve is made of a self-lubricating material. The self-lubricating bearing is sleeved onto the spindle and located at one end of the axial hole. The ball valve includes a through hole running through an axis thereof and sleeved onto one end of the spindle relative to the self-lubricating bearing. The ball valve includes a spherical external periphery. The external diameter of the bushing is smaller than the internal diameter of the axial hole. The bushing includes a spherical bushing aperture recessed from a axis thereof for engagement with the ball valve to make the bushing be deflected for a predetermined angle on the center of the ball valve and in this way, the rotation of the spindle remains stable and smooth.

Preferably, each of the self-lubricating bearing, the bushing, and the ball valve is made of a wearable engineering plastic material.

Preferably, the main body is a bottom bracket of a bicycle frame and includes an internal thread formed at each of two ends of the axial hole. The main body further includes two seal caps, each of which has a circular hole for the spindle to pass through. One of the circular holes is a polygonal bushing aperture and the other is an external thread for threaded connection with the internal thread of the axial hole.

Preferably, the main body is a pedal of a bicycle and the axial hole is formed of a large-diameter portion and a small-diameter portion. The spindle includes an external thread formed at one of two ends thereof for threaded connection with a crank of a bicycle and a fitting portion formed at the other end thereof and having a smaller diameter than that of the external thread for the pivotal assembly to be sleeved into.

### BRIEF DESCRIPTION OF THE DRAWINGS

FIG. 1 is an exploded view of a first preferred embodiment of the present invention.

FIG. 2 is a sectional view of the first preferred embodiment of the present invention.

FIG. 3 is similar to FIG. 2, illustrating that the bushing of the pivotal assembly is deflected for a predetermined angle.

FIG. 4 is an exploded view of a second preferred embodiment of the present invention applied to a bicycle crank.

FIG. 5 is a perspective view of the second preferred embodiment of the present invention.

FIG. 6 is a sectional view of the second preferred embodiment of the present invention.

### DETAILED DESCRIPTION OF PREFERRED EMBODIMENTS

Structural features and desired effects of the present invention will become more fully understood by reference to two preferred embodiments given hereunder. However, it is to be understood that these embodiments are given by way of illustration only, thus are not limitative of the claim scope of the present invention.

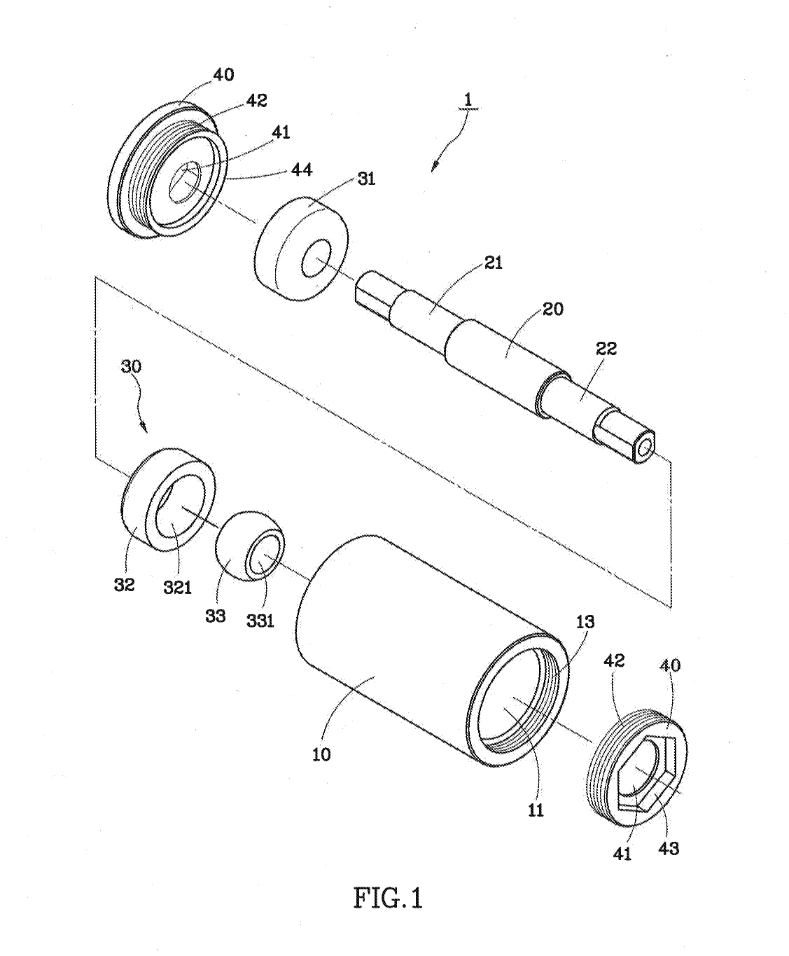

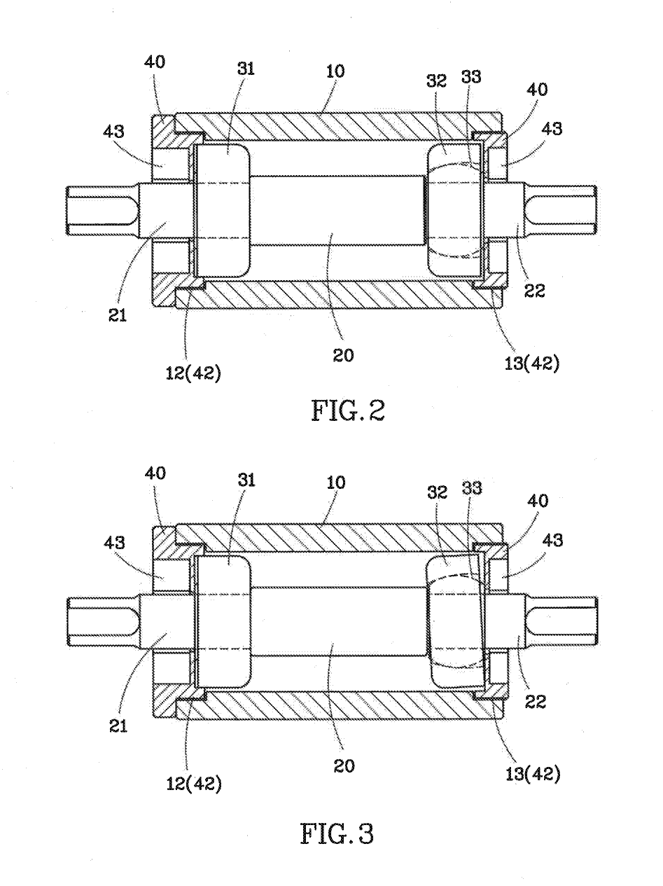

Referring to FIGS. 1 and 2, a bottom racket assembly 1 for low-speed rotation in accordance with a first preferred embodiment of the present invention is formed of a main body 10, a spindle 20, a pivotal assembly 30, and two seal caps 40. The detailed descriptions and operations of these elements as well as their interrelations are recited in the respective paragraphs as follows.

The main body 10 includes an axial hole 11 and two internal threads 12 and 13 formed at two ends of the axial hole 11, respectively, and can have a predetermined shape structurally or combined with another component. For example, in this embodiment, the main body 10 is a bottom bracket and can be fixedly connected with a seat tube (not shown), a down tube (not shown), and a chain stay (not shown) of a bicycle (not shown).

The spindle 20 is an elongated circular bar and includes two fitting portions 21 and 22 formed at two ends thereof, respectively. Each of the fitting portions 21 and 22 is provided with a smaller diameter than that of a central part of the spindle 20.

The pivotal assembly 30 includes a self-lubricating bearing 31, a bushing 32, and a ball valve 33. The self-lubricating bearing 31 is made of a self-lubricating and wearable engineering plastic material and sleeved onto the fitting portions 21 to be right received into the axial hole 11. Each of the bushing 32 and the ball valve 33 is also made of a self-lubricating and wearable engineering plastic material. The bushing 32 is provided with an external diameter that is larger than an internal diameter of the axial hole 11. A spherical bushing aperture 321 is opened through an axis of the bushing 32. The ball valve 33 includes a spherical surface and can be plugged right into the bushing aperture 321 for rotation relative to the bushing 32. A though hole 331 is opened through an axis of the ball valve 33 for one of the fitting portions 22 to pass through.

Each of the two seal caps 40 includes a circular hole 41. Each of the circular holes 41 includes two ends, one of which is an external thread 42 and the other is a polygonal bushing aperture 43 for a tool (not shown), like a wrench, to be inserted into. When the tool is inserted into the polygonal bushing aperture 43, the user can operate the tool to turn the seal cover 40 to further make the seal caps 40 combined to two sides of the axial 11, respectively. The circular hoe 41 of each seal cap 40 includes a retaining portion 44 formed at a midsection thereof. When the seal caps 40 are screwed with the internal threads 12 and 13, respectively, the retaining portions 44 confine and prevent the self-lubricating bearing 31 and the bushing 32 from disengagement from the axial hole 11.

The present invention is characterized in that when the spindle 20 and the pivotal assembly 30 are mounted into the axial hole 11, even if the internal periphery of the axial hole 11 is not precisely processed, the spindle 20 can keep stable and smooth rotation, as shown in FIG. 3, because the bushing 32 and the ball valve 33 are in ball joint with each other. In other words, the bushing 32 and the ball valve 33 can be pivotably connected with each other, like a universal joint, to make the spindle 20 mounted between the self-lubricating bearing 31 and the ball valve 33 function as automatic calibration. The present invention not only decreases the frequency and time for applying precise processing to the axial hole 11 but reduces the number of the conventional metallic bail bearings or generic bearings to further lower the production and assembly cost dramatically.

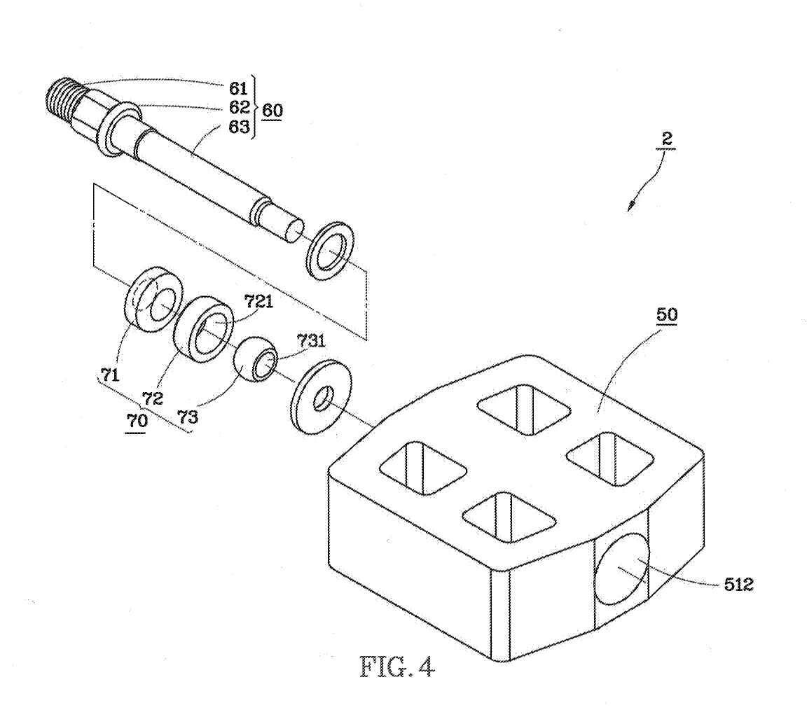

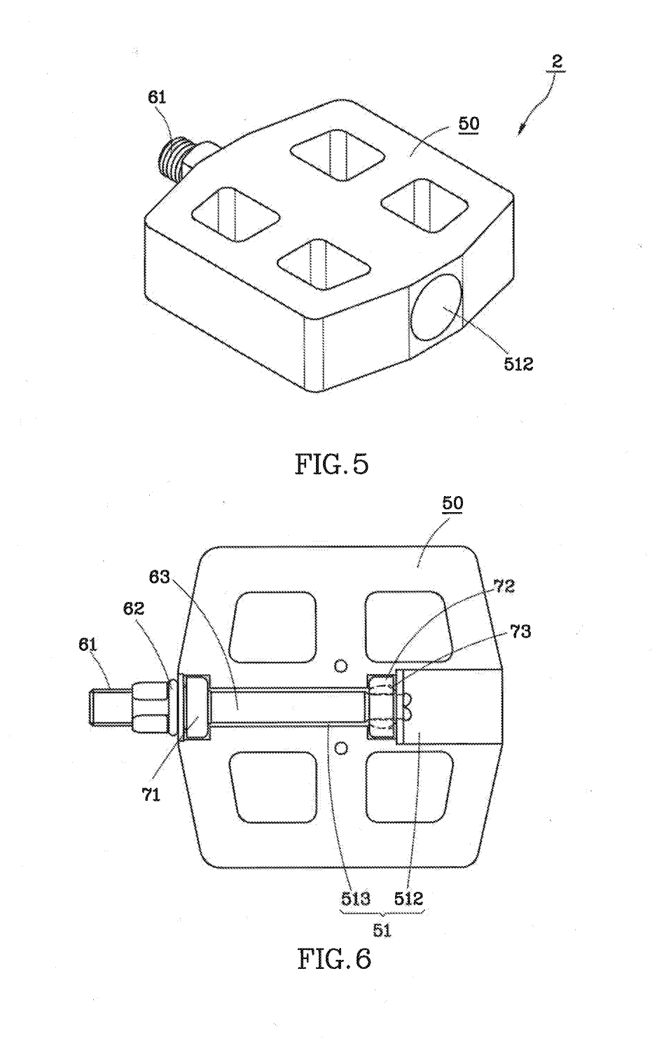

Referring to FIGS. 4-6, a bottom bracket assembly 2 for low-speed rotation in accordance with a second preferred embodiment of the present invention is applied to a pedal of a bicycle (not shown). The bottom bracket assembly 2 is formed of a pedal body 50, a spindle 60, and a pivotal assembly 70.

The pedal body 50 is a flat plate and includes an axial hole 51 and two accommodation portions 511 and 512. The axial hole 51 is formed at a midsection of the pedal body 50 and runs through the pedal body 50. The two accommodation portions 511 and 512 are formed at two ends of the axial hole 51, respectively, and each have a larger diameter than that of the axial hole 51.

The spindle 60 is an elongated circular bar and includes an external thread 61 formed at one of two ends thereof for threaded connection with a crank (not shown), a stepped portion 62 formed at a midsection thereof, and a fitting portion 63 formed at the other end and having a smaller diameter than that of either of the external thread 61 and the stepped portion 62.

The pivotal assembly 70 includes a self-lubricating bearing 71, a bushing 72, and a ball valve 73. The self-lubricating bearing 71 is made of a self-lubricating and wearable engineering plastic material. The self-lubricating bearing 71 is sleeved onto the fitting portion 63 and right received inside the accommodation portion 511. Each of the bushing 72 and the ball valve 73 is also made of a self-lubricating material. The external diameter of the bushing 72 is a little smaller than the internal diameter of the accommodation portion 512. The bushing 72 includes a spherical bushing aperture 721 recessed from an axis thereof. The ball valve 73 includes a spherical surface right plugged into the bushing aperture 721 for rotation relative, to the bushing 72. A through hole 731 runs through the axis of the ball valve 73 for the fitting portion 22 to be sleeved into.

After the spindle 60 is sleeved into the self-lubricating bearing 71, the bushing 72, and the ball valve 73, the spindle 60 is inserted into the axial hole 51 and meanwhile, the stepped portion 62 is stopped against one end of the axial hole 51 and the fitting portion 63 passes through and goes out of the accommodation portion 512. Finally, stamping rivet joint is applied to an end edge of the accommodation portion 512 for expanded rivet joint processing to keep the pivotal assembly 70 received into the axial hole 51 and to prevent the pivotal assembly 70 from disengagement from the axial hole 51.

Likewise, the bushing 72 and the ball valve 73 are in ball joint with each other. When the bushing 72 and the ball valve 73 are mounted into the axial hole 51, the spindle 60 can keep stable and smooth rotation. In other words, the frequency and time for applying precise processing to the axial hole 11 can also be decreased and the number of the conventional metallic ball bearings or generic bearings can also be reduced, thus dramatically lowering the production and assembly cost of the bicycle pedal.

In conclusion, the bottom bracket assembly for low-speed rotation not only makes the spindle keep stable and smooth rotation but increases the convenience of the assembly process and dramatically lowers the cost of components used. In addition, the present invention can be not only applied to the aforesaid bottom bracket or bicycle pedal but a wheel or a roller.

What is claimed is:

1. A bottom bracket assembly for low-speed rotation, comprising:
a main body having an axial hole running therethrough;
a spindle inserted into the axial hole; and
a pivotal assembly having a self-lubricating bearing, a bushing, and a ball valve, each of the self-lubricating bearing, the bushing, and the ball valve being made of a self-lubricating material, the self-lubricating bearing being sleeved onto the spindle and located at an end of the axial hole, the ball valve having a through hole running through its axis for an end of the spindle to be sleeved into relative to the self-lubricating bearing, the bushing having an external diameter that is smaller than an internal diameter of the axial hole, the bushing having a spherical bushing aperture recessed from its axis for engagement with the ball valve to make the bushing rotate on a center of the hall valve for a predetermined angle.

2. The bottom bracket assembly as defined in claim 1, wherein each of the self-lubricating bearing, the bushing, and the ball valve is made of a wearable engineering material.

3. The bottom bracket assembly as defined in claim 1, wherein the main body is a bottom bracket of a bicycle frame and the axial hole is provided with two internal threads formed at two ends thereof; the bottom bracket assembly further comprises two seal caps, each of the seal caps having a circular hole for the spindle to pass through, each seal cap having two ends, one of which is a polygonal bushing aperture and the other is an external thread for threaded connection with one of the internal threads.

4. The bottom bracket assembly as defined in claim 1, wherein the main body is a pedal of a bicycle and the axial hole is formed of a large-diameter portion and a small-diameter portion; the spindle comprises two ends, one of which is an external thread for threaded and fixed connection with a crank of a bicycle and the other is a fitting portion having a smaller diameter than that of the external thread for the pivotal assembly to be sleeved onto.

5. The bottom bracket assembly as defined in claim 4, wherein the spindle further comprises a stepped portion formed at a midsection thereof for contacting against an end of the axial hole.
